(19) United States
(12) Patent Application Publication
(10) Pub. No.: US 2004/0202429 A1
(43) Pub. Date: Oct. 14, 2004

(54) Planar optical component for coupling light to a high index waveguide, and method of its manufacture

(75) Inventors: Moti Margalit, Zichron Yaaqov (IL); Nikolai Berkovitch, Nesher (IL); Yoav Gross, Rehovot (IL)

Correspondence Address: Ladas & Parry, 26 West 61 Street, New York, NY, 10023, US

(73) Assignee: LAMBDA CROSSING LTD.

(21) Appl. No.: 10/411,081

(22) Filed: Apr. 10, 2003

(51) Int. Cl. G02B 6/30

(52) U.S. Cl. 385/49

(57) ABSTRACT

A planar optical component is presented that defines an optical path for light propagation in between a first waveguide and an optical fiber. The optical component comprises a waveguide structure defining a transition region between the first waveguide and the optical fiber, the transition region is formed by first and second cladding layers and first and second core segments. The first core segment is formed by a core of said first waveguide having a refractive index n₁, and the second core segment is formed by a core of a second connecting waveguide having a refractive index n₂<n₁. The first and second core segments are physically adjacent to one another all along the transition region such that the first core segment is spaced from at least one of the cladding layers by said second core segment. A cross-sectional size of the first core segment is reduced along the transition region in a direction towards the optical fiber, thereby forming a sloped interface shorted than 1 mm. This configuration provides for that at that end of the transition region, where the cross-sectional size of the first core segment is minimal, an optical field is confined primarily in the second connecting waveguide.

### FIELD OF THE INVENTION

This invention relates to optical circuits, and in particular, to planar optical circuits utilizing an optical taper, and a method of manufacturing thereof.

### BACKGROUND OF THE INVENTION

Optical communications is based on the generation, transmission and detection of information on a light channel. The transmission is usually done by using an optical fiber, which provides a low loss medium for transferring light over large distances with low distortion. The generation and detection of data is provided by a variety of optoelectronic devices, including laser diodes, optical amplifiers, electro-optic switches, modulators, splitters, wavelength routers, filters, optic fibers and detectors. In many cases, the optical mode of the fiber has different spatial profiles than the profile of the output of the devices. Moreover, it is often the case that optical devices utilize waveguides for internal routing of light, and the spatial profiles of these waveguides may differ significantly from those of the optical fiber. The spatial mismatch results in loss of optical power. Furthermore, in optical devices with high index contrast waveguides, the optical field is tightly confined, which results in tight fabrication and assembly tolerances, increased cost and lower yields.

Generally, two main approaches are known in the art for optical coupling and providing efficient energy transfer between such different spatial mode profiles. According to one approach, various discrete optical elements are used for creating mode adaptation optics, which can be realized by using lens arrangements, diffractive optical elements or collimating optics. The other approach is based on adiabatic energy transfer between light guiding structures, for example by using gratings or other resonant structures, or by adiabatic tapering the dimensions or refractive index of the waveguides (e.g., “Integrated Optic Adiabatic Devices on Silicon”, Y. Shani et al., IEEE Journal of Quantum Electronics, Vol. 27, No. 3, March 1991. In most cases, the two approaches are combined.

Increasing or decreasing the dimensions of the waveguide structures to obtain matching core sizes can realize adiabatic mode conversion. The resultant mode needs to conform to the spatial profile of the fiber mode.

In some cases (materials), it is possible to create large optical structures in which mode profile can be expanded from a small mode (as small as a fraction of a micron) to the mode of standard single mode fiber (which is about ten microns). FIG. 1A illustrates a taper structure utilizing a tapered rib waveguide tapering from a large multi-mode waveguide to a smaller single-mode waveguide [U.S. Pat. No. 6,108,478]. The waveguides are in the form of ribs formed on the upper surface 1 of a silicon-on-insulator chip, with an oxide layer 2 separating the silicon layer 1 from a silicon substrate 3. The tapered rib waveguide comprises two portions: a lower portion 4 which tapers laterally from a width of about 10 microns to a width of about 4 microns over a length of about 1000 microns, and an upper portion 5, formed on the lower portion 4, which tapers from a width of about 10 microns to a point over a length of about 800 microns. The upper portion 5 thus tapers more rapidly than the lower portion 4. Both portions are designed to provide a substantially adiabatic taper.

The complication of the anti-reflection coating, the possibility of high order optical mode generation, and the fact that in most cases it is impossible to create a large enough high index waveguide lead to the other option of coupling where a high refractive index waveguide is reduced to become sub critical, and is coupled to an optical fiber via an additional waveguide. By this, the optical mode expands dramatically and can be adapted for efficient coupling to the fiber.

FIG. 1B illustrates a structure designed to provide adiabatic mode conversion from one waveguide to another by mode tapering [U.S. Pat. No. 5,078,516]. Here, the width W₂ of a shoulder rib 34 in the vicinity of the tapered portion 38 of the upper rib 36 is tapered to form a lower tapered portion 40, i.e., the shoulder and upper ribs 34 and 36 are both tapered.

In particular, in high refractive index difference waveguides the optimum core size for a single mode waveguide is significantly smaller than the core size of a typical optical fiber. In general, the reduced cross-sectional dimensions of the waveguide are necessary to maintain single-mode light propagation through the waveguide, since the multi-mode propagation associated with larger cross-sectional dimensions results in unacceptable losses of light intensity (i.e., loss of signal and a decrease in the signal-to-noise ratio). This difference in the core size has important implications in coupling efficiency between the core of a planar integrated circuit waveguide and the core of an input/output fiber attached to the integrated circuit. The coupling loss between the fiber and the planar integrated circuit is minimized when the mode of the optical beam is preserved, i.e., the fiber and the integrated circuit have matched optical modes.

FIG. 1C illustrates a planar optical component (such as switch) described in U.S. Pat. No. 6,253,015. Here, the component is composed of a substrate 11 carrying a lower cladding layer 12, in which first and second transition regions 26 and 27 are formed, and an upper cladding layer 20. In the transition region, which is of a 1000 μm length), a first patterned segment 18 with a relatively low refractive index core material is formed on top of a second patterned segment 14 with a relatively high refractive index core material, and a tapered or sloped interface is defined between the high and low refractive index cores.

### SUMMARY OF THE INVENTION

There is a need in the art for, and it would be useful to have, an optical planar component allowing an effective energy transfer between different spatial mode profiles through said optical component.

The optical component of the present invention is a waveguide structure composed of several optical layers, defining a relatively short transition region (taper) between a light input/output system (optical fiber) and a high refractive index waveguide (an input/output waveguide of a functional optical device). The taper of the present is designed to provide sufficient adiabatic energy transfer at as short as possible taper's length. The transition region is formed by first and second core segments of first and second waveguides of different refractive indices extending physically adjacent to one another all along the transition region. The cross sectional size of the higher index core segment (which is the core segment of said high index waveguide) reduces along the transition region, until an optical field is confined primarily in the second waveguide.

The optical structure of the present invention provides for interconnecting electro-optical devices (such as switches, filters, attenuators, etc.) with differing optical mode profiles. The invented structure allows for adiabatic transmission of the fundamental mode of a photo-optic signal from a light transmission device (fiber or an electro-optical device) at the input end of the structure to a different electro-optical device at the output end of the structure. In other words, the optical structure can operate without loss, i.e., without power transfer to higher order local modes or to a radiation mode. The input and output ends of the optical structure are configured to match the optical mode profiles of the devices that the waveguide interconnects.

There is thus provided according to one broad aspect of the present invention, a planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region such that the first core segment is spaced from at least one of the cladding layers by said second core segment, a cross-sectional size of the first core segment being reduced along the transition region in a direction towards the optical fiber, thereby forming a sloped interface shorted than 1 mm, at that end of the transition region where the cross-sectional size of the first core segment is minimal an optical field being confined primarily in the second connecting waveguide.

The dimensions and refractive indices of the first and second core segments are selected such that the first and second core waveguides are single mode waveguides. For example, the first core segment has the refractive index of about 1.6-3.5, and the cross-sectional size ranging from 0.1-4 micron, e.g., a height of about 0.1-1 micron and a width of about 0.5-4 micron. The second core has the refractive index of about 1.45-1.6, and a size of about 1-10 micron, e.g., a height of about 0.2-10 micron and a width of about 1-10 micron. The cladding layer has a thickness of about 3-20 micron, and the refractive index of about 1.45.

The arrangement may be such that the first sloped core segment is located on top of the first cladding layer and is spaced from the second cladding layer by the second core segment; the first slopped core segment is located in top of the second substantially planar core segment and is spaced from the first cladding layer by the second core segment; or the first core segment is located inside the second core segment and is therefore spaced from both the first and second cladding layers by the second core segment material.

The reduction of the cross-sectional size of the first core segment may result from a reduction of the first core segment in one or two dimensions.

The optical component may include an additional transition region. The two transition regions are arranged in a spaced-apart relationship between the first and second cladding layers. The additional transition region includes an additional first core segment extending along the additional transition region while being physically adjacent to a second core segment on top thereof, wherein the additional first core segment has a refractive index higher than those of the cladding layers and the second core material and has a reduced cross-sectional size all along the additional transition region in a direction parallel to the cross-sectional size reduction of said first core segment. The second core segments of the two transition regions may be segments of the same core layer.

The first core segment may be made from the following: Silicon, Silicon Nitride, Tantalum Pent Oxide, optical polymers, Zinc Oxide, or sol gel based glasses. As for the second core segment material, it may include: Silicon Oxide, Germanium doped silicon oxide, silicon oxinitride, sol gel glasses or optical polymers.

According to another aspect of the invention, there is provided a planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region, the first core segment being located inside the second core segment and being spaced from the cladding layers by said second core segment material, a cross-sectional size of the first core segment being reduced along the transition region in a direction towards the optical fiber, thereby forming a sloped interface between the first and second core segments, such that at that end of the transition region where the cross-sectional size of the first core segment is minimal an optical field is confined primarily in the second connecting waveguide.

According to yet another aspect of the invention, there is provided a planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region, the first core segment being located on top of the second core segment and being spaced from one of the cladding layers by said second core segment material, a cross-sectional size of the first core segment being reduced along the transition region in a direction towards the optical fiber, thereby forming a sloped interface between the first core segment and the other cladding layer, at that end of the transition region where the cross-sectional size of the first core segment is minimal an optical field being confined primarily in the second connecting waveguide.

According to yet another aspect of the invention, there is provided an optical device having a functional optical element connectable to at least one optical fiber via at least one first waveguide, the optical device comprising a taper structure located at an input/output facet of the device and defining an optical path for light propagation in between said at least one first waveguide and said at least one optical fiber, the taper structure comprising a waveguide structure defining at least one transition region between, respectively, the at least one first waveguide and the at least one optical fiber, the transition region being formed by first and second cladding layers and first and second core segments, the first core segment being formed by a core of said first waveguide having a refractive index n₁, and the second core segment being formed by a core of a second connecting waveguide having a refractive index n₂<n_{1,} the first and second core segments being physically adjacent to one another all along the transition region such that the first core segment is spaced from at least one of the cladding layers by said second core segment, a cross-sectional size of the first core segment being reduced along the transition region in a direction towards the optical fiber, thereby forming a sloped interface shorted than 1 mm, at that end of the transition region where the cross-sectional size of the first core segment is minimal an optical field being confined primarily in the second connecting waveguide.

The optical device may comprise at least one additional first waveguide connecting said functional element to an optical fiber via the taper structure on said input/output facet of the device. This additional waveguide may be an input/output waveguide of the functional element being configured as a curve realizing a 180° turn. The functional optical element may be operable to effect a change in light propagation direction via at least one of the first waveguides. In the absence of a high index contrast layer (i.e., first waveguide core having a refractive index of about 1.6-3.5), the 180° would require extended chip real estate. Hence, the combination of a high index contrast waveguides and tapers enables the creation of a compact optical chip whose output and input are located on the same side of the chip. This simplifies the packaging of the chip since light needs to be coupled to a single facet only.

The present invention, according to yet another aspect, provides a method of manufacturing an optical component utilizing either a gray scale mask or a moving mask with a slit to pattern the first core layer in the vertical dimension.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIGS. 1A to 1C are schematic illustrations of the state of the art tapering techniques utilizing;

FIG. 2 schematically illustrates an optical device utilizing a planar optical component (taper) according to the invention;

FIGS. 3A to 3E illustrate one example of the planar optical component according to the invention, wherein FIGS. 3B-3E show cross-sectional views of the structure of FIG. 3A taken along lines B-B, C-C, D-D and E-E, respectively;

FIGS. 4A to 4E illustrate another example of the planar optical component according to the present invention, FIGS. 4B-4E show cross-sectional views of the structure of FIG. 4A taken at lines B-B, C-C, D-D and E-E, respectively;

FIGS. 5A-5C illustrate the principles of the optical mode coupling between an optical fiber and the taper of the present invention, wherein FIG. 5A shows the Gaussian mode distribution in the optical fiber, FIG. 5B shows the fundamental mode of a connecting waveguide matching the optical fiber, and FIG. 5C shows the fundamental mode of the complex structure of the taper composed of the fiber matching waveguide and a high-index waveguide placed inside;

FIGS. 6A to 6D illustrate cross-sectional views of a planar optical component (taper) according to yet another example of the invention;

FIGS. 7A and 7B illustrate a taper structure according to yet another example of the invention;

FIGS. 8A and 8B illustrate, respectively, the mode field diameter as a function of the cross-section size of the high-index core waveguide, and the effective index as a function of the cross-section size of the high-index core waveguide in the taper structure according to the invention;

FIGS. 9A and 9B illustrate, respectively, the transition region losses as a function of the linear vertical taper length, and the transition region losses as a function of the vertical taper exponent, in the device of the present invention;

FIG. 10 illustrates losses as function of taper end height in the device of the present invention;

FIGS. 11 and 12A-12C exemplify the manufacture of the device according to the invention using gray scale lithography, wherein FIG. 11 shows the photoresist thickness as a function of exposure energy; FIG. 12A illustrates the use of a gray scale mask, FIG. 12B illustrates the use of a moving slit apparatus, and FIG. 12C shows the resulted photoresist profile; and

FIGS. 13A and 13B exemplify the manufacture of the device according to the invention using vertical lithography by wide slit moving mask, wherein FIG. 13A shows a wide slit moving mask at t=0 (start of exposure) and FIG. 13B shows a wide slit moving mask at t=Tₒ (end of exposure);

FIGS. 14A and 14B exemplify optical devices utilizing the taper structure of the present invention for coupling input/output fibers and a functional optical element at the same facet of the device; and

FIGS. 15A and 15B exemplify optical chip devices of the present invention with arbitrary output direction from, respectively, a photonic bandgap device and a ring resonator device.

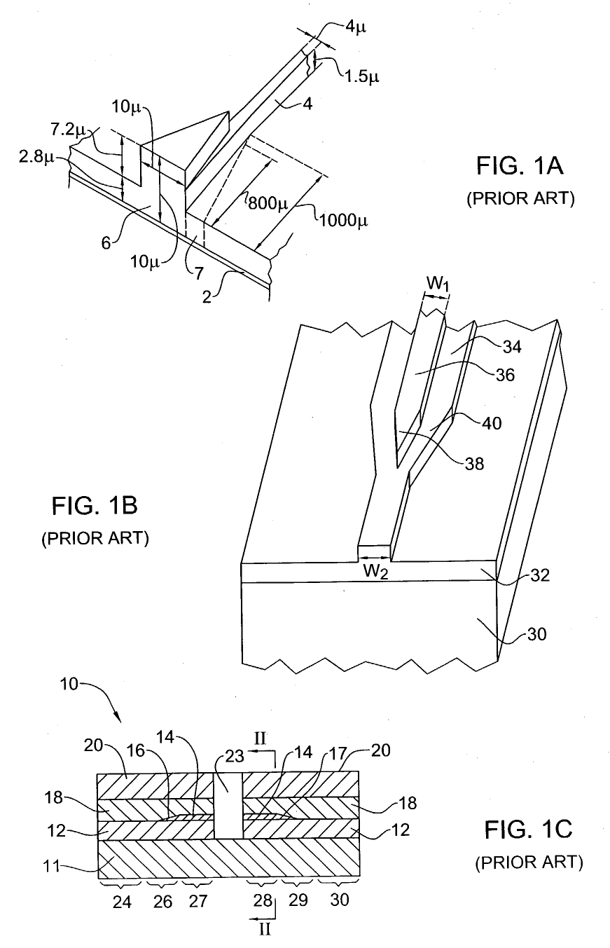

### DETAILED DESCRIPTION OF THE INVENTION

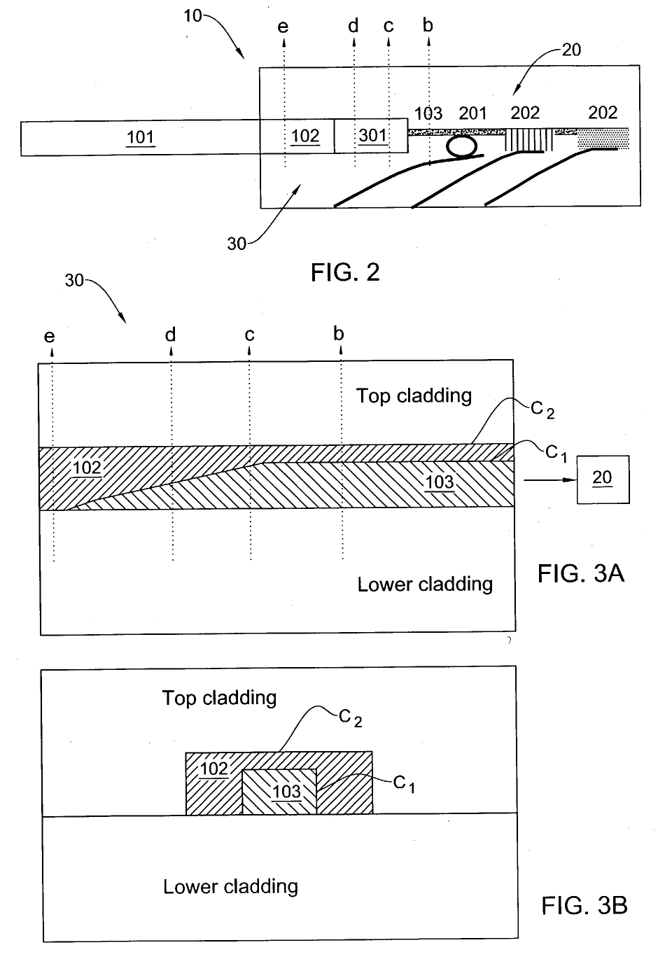

Referring to FIG. 2, there is illustrated an optical system 10 having a functional optical circuit 20 coupled to a light transmission system (an optical fiber) 101 via a planar optical component (taper) 30 according to the invention. The functional optical circuit 20 may comprise different optical waveguides and elements, for example operating as a frequency-selective filter. As exemplified in FIG. 2, the circuit 20 comprises an input/output waveguide 103 and a frequency selective element, which may be in the form of a close-loop (ring) resonator 201, a grating 202, and/or photonic crystal 203. These frequency-selective elements have been outlined extensively in the literature as relating to an important class of integrated optical elements, requiring a high core to cladding index difference.

The planar optical component 30 is configured to define a connecting waveguide region 102 and a transition region 301, and serves for coupling light in between the functional optical circuit 20, namely, its input/output waveguide 103, and the input/output fiber 101 of the entire system 10. The planar optical component 30 is formed by lower and upper cladding layers, and two core layers between the cladding layers, the core layers being constituted by the core segments of the waveguides 102 and 103. These core segments extend all along the transition region 301 being in physical contact with one another. The core segment of the waveguide 103 (or alternatively, the core segments of both waveguides 102 and 103) has a gradually varying cross-section size within the transition region, such that the cross-sectional size of the core segment of the waveguide 103 gradually reduces in a direction towards the waveguide region 102, as will be exemplified further below.

To facilitate a low loss connection to the fiber 101, the connecting waveguide 102 is designed to have an optical mode matching that of the fiber 101, namely to support the optical mode propagating from the fiber 101 to the waveguide 102. Generally, this could be implemented by designing the connecting waveguide 102 with the cross-section and the core to cladding refractive index difference substantially equal to those of the optical fiber 101. Preferably, however, the matching between the optical modes of the fiber 101 and waveguide 102 is implemented by designing the connecting waveguide 102 with the cross section smaller and the core to cladding refractive index difference higher than those of the fiber 101. This configuration results in that the optical mode from the fiber 101 enters the connecting waveguide structure 102, and, while being supported by the waveguide 102, is mostly distributed in the cladding of the waveguide structure 102 rather than in the core thereof. A structure utilizing this preferred configuration is more likely to be a single mode waveguide structure than those utilizing a connecting waveguide with a large cross section size appropriate to an optical fiber. In the transition region 301, the optical mode is expanded from the waveguide 103 to the connecting waveguide 102. The transition is done in an adiabatic manner to prevent excitation of high order optical modes, which would manifest a loss on the transition.

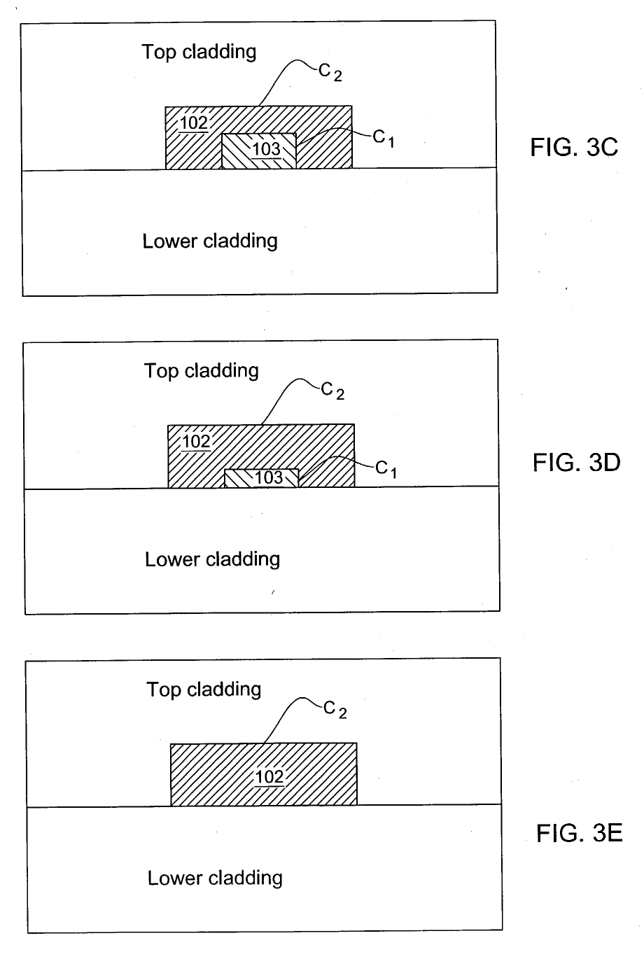

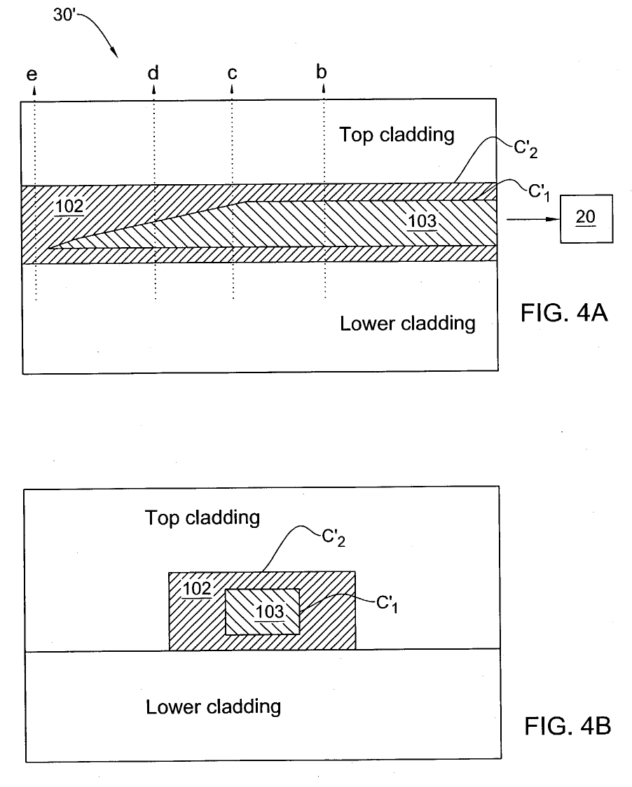

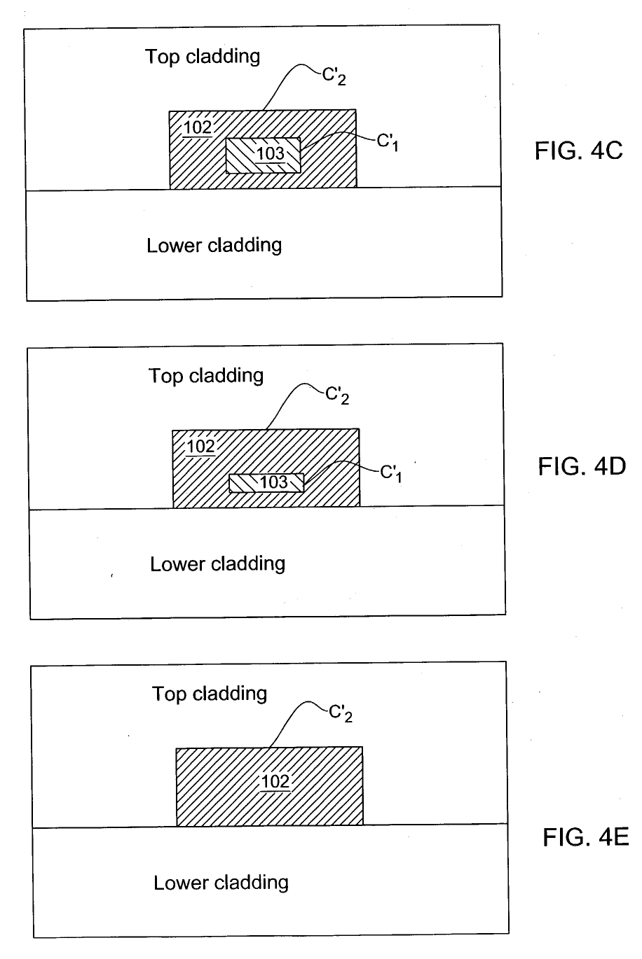

FIGS. 3A-3E and 4A-4E exemplify planar optical components 30 and 30′ of the present invention, differing from each other in the implementation of the transition region 301 due to the different geometry of a relatively high refractive index core segment C₁ of the waveguide 103, and consequently the geometry of a relatively low refractive index core segment C₂ of the connecting waveguide 102 depending on the accommodation of the core C₁ with respect to the core C₂. FIGS. 3B-3E show cross-sectional views of the structure shown in FIG. 3A, taken along lines B-B, C-C, D-D and E-E, respectively, and FIGS. 4B-4E show the same of the structure of FIG. 4A.

In both components 30 and 30′, the two core segments C₁ and C₂ of the waveguides 102 and 103, respectively, extend adjacent to one another all along the transition region 301, with both core layers C₁ and C₂ existing in the start of the transition region at the side of the functional device 20, and with both core segments C₁ and C₂ having a varying cross-sectional size. In the example of FIGS. 3A-3E, the core layer C₂ partly surrounds the core segment C₁, while the remaining part of the core segment C₁ interfaces with the lower cladding layer. In the example of FIGS. 4A-4E, the core segment C₁ is fully surrounded by the core layer C₂, i.e., the core C₁ is located completely inside the core C₂, which interfaces with the lower and upper cladding layers.

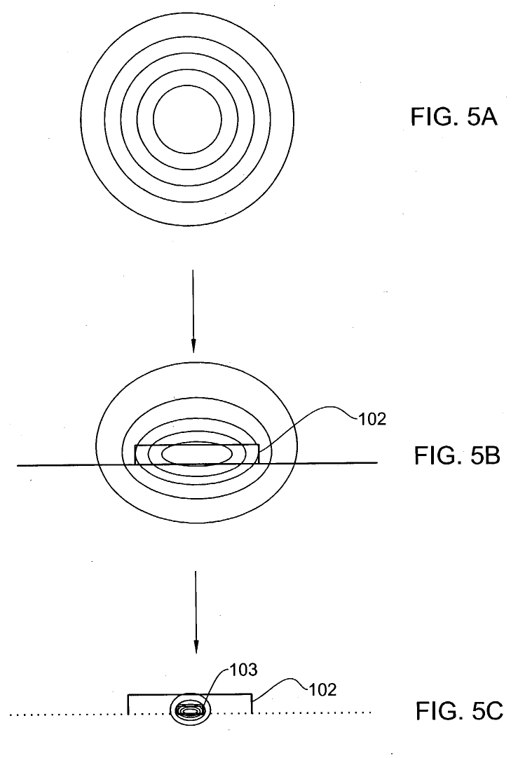

FIGS. 5A-5C illustrate the principles of the optical mode coupling between the light transmission system (fiber) 101 and the taper 30 (or 30′). Here, FIG. 5A shows the Gaussian mode distribution in the optical fiber 101, FIG. 5B shows the fundamental mode of the connecting waveguide 102 matching the optical fiber 101, and FIG. 5C shows the fundamental mode of the complex structure of the taper composed of the fiber matching waveguide 102 and the high-index waveguide 103 placed inside. As the size of the waveguide 103 is reduced (in either vertical or horizontal dimension), the optical mode expands and the effective refractive index is reduced. When the effective index is similar to the low index contrast waveguide 102, the high index waveguide 103 is no longer dominant in defining the optical mode, which is now defined by the combination of both cores C₁ and C₂. As the high index core C₂ is further reduced in size, the low index waveguide 102 becomes dominant in defining the spatial profile of the optical mode.

The technique of the present invention can be used to facilitate multilevel planar lightwave circuits. Multilevel circuits are especially advantageous for reducing the size of optical devices and for providing higher functional density by using the vertical dimension and stacking optical elements. The following are two more examples of the planar optical component (taper) according to the invention utilizing this concept.

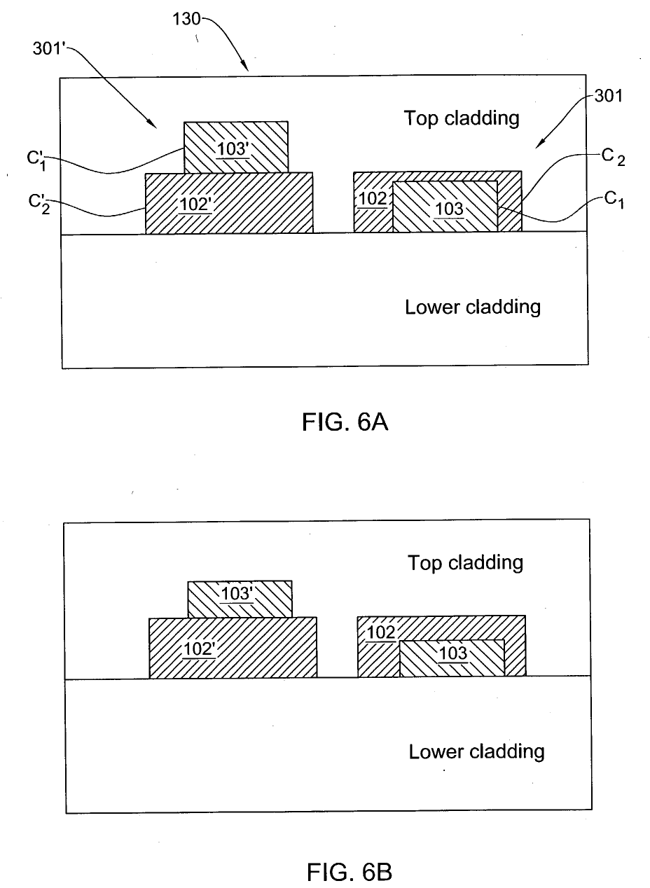

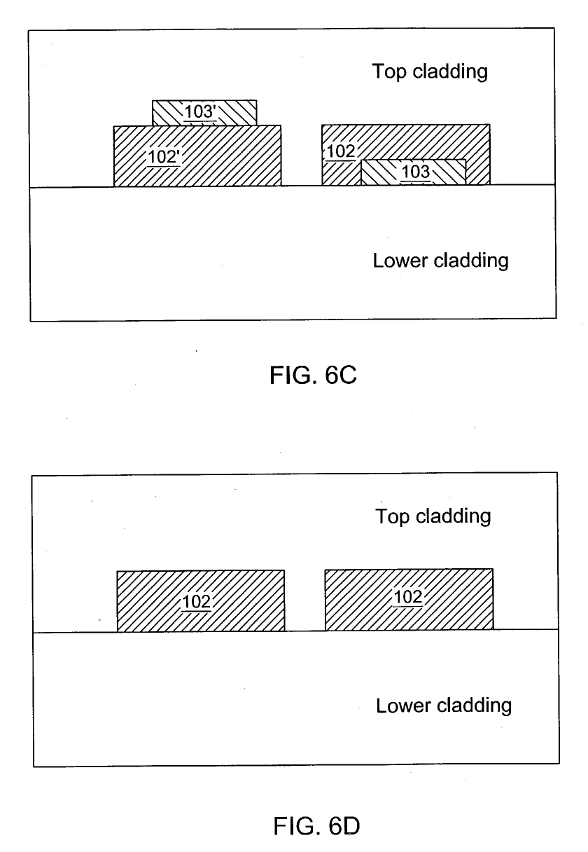

FIGS. 6A-6D illustrate cross-sectional views of a planar optical component (taper) 130 corresponding to different sections taken along the component, similar to the above-described examples of FIGS. 3B-3D and 4B-4D. The component 130 is generally similar to the previously described component 30 but, in addition to the transition region 301 formed by the cores C₁ and C₂ of waveguides 102 and 103, has a transition region 301′ formed by cores C′₁ and C′₂ of, respectively, a connecting waveguide region 102′ and an input/output waveguide 103′ of an additional functional device. The two structures 102-103 and 102′-103′ are arranged in a spaced-apart relationship each between the lower and upper cladding layers. In the structure 102-103, the core segments C₁ and C₂ are configured as in the above-described example of FIGS. 3A-3E (or 4A-4E), namely, both core segments C₁ and C₂ are patterned (have a varying cross-sectional size), and in the structure 102′-103′, only the core segment C′₁ of the higher index layer is patterned to have a gradually reduced cross-sectional size and is located on top of the core segment C′₂.

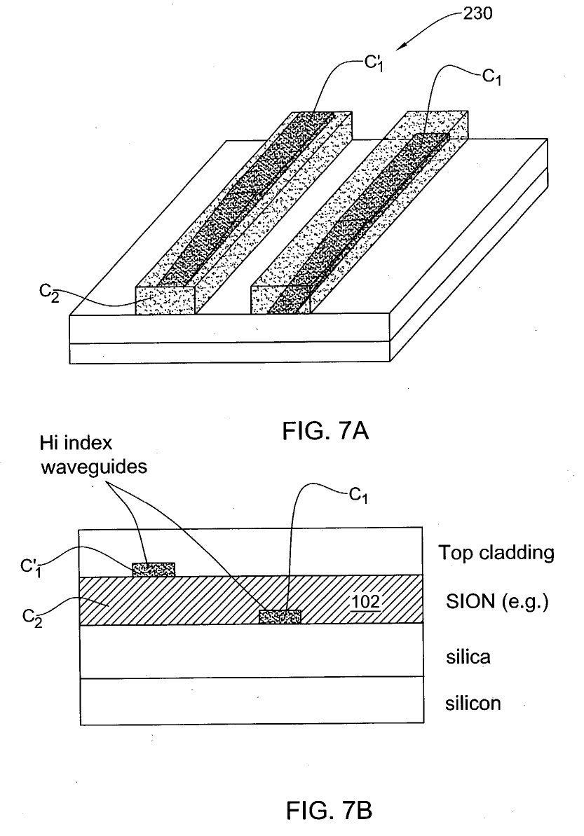

FIGS. 7A-7B exemplify a planar optical component 230 having an expanded transition region to provide a common interface for both layers. As shown in the figures, the common low index contrast waveguide layer C₂ is used to couple to the high index core waveguides C₁ and C₁′, situated at different vertical locations. Since the low index layer C₂ is common, the interface to external fiber array is at a common vertical position, thereby facilitating coupling into both layers. Each of the high index cores C₁ and C₁′ is tapered as described above and leads light propagating there through from the common vertical position at one side to the two distinct layers at the other side.

The layer materials in the planar optical component of the present invention are selected such that the refractive indices n₁ and n₂ of the core segments C₁ and C₂ (or C′₁ and C′₂), respectively, are larger than that of the cladding layers, and n₁>n₂. The cladding layers may be made of the same or different materials, provided they have refractive indices less than those of the core layers. Generally, the construction is such that at the start of the transition region (at the input/output side of the functional deice) most part of the optical mode is confined within the high index core layer C₁ (or C′₁), and therefore this core is dominant in defining the profile of the mode in the various element sections, and the second, lower refractive index core material C₂ functions as a cladding material for the high index waveguide(s). To facilitate the transition, the cross-sectional size of the waveguide core C₁ (or C′₁) is reduced in a direction from the functional device 20 towards the optical fiber 101 with the continuous transition of the most of optical mode confinement within the high index core layer C₂ (or C′₂) at the side of the optical fiber 101. The geometry of the core segments C₁ and C₂ and the relation between the materials' refractive indices provides for obtaining a single mode coupling between the fiber 101 and the waveguide 103 with a relatively short taper, i.e., substantially not exceeding 1000 microns, preferably about several hundreds of microns, e.g., 500 microns.

The taper device of the present invention can be fabricated using a wide variety of materials. The high index core material C₁ may include at least one of the following: Silicon, Silicon Nitride, Tantalum Pent Oxide, optical polymers, Zinc Oxide, and sol gel based glasses. The low index waveguide C₂ and cladding layers may include at least one of the following materials: Silicon Oxide, Germanium doped silicon oxide, silicon oxinitride, sol gel glasses and optical polymers. The materials may be deposited using LPCVD, PECVD, PVD, Flame hydrolysis, or spin coating. The bottom cladding layer, as well as the top cladding layer, is preferably of about 10-20 micron in thickness and has the refractive index of about 1.4-1.7. The high index layer C₁ can have a refractive index of 1.6-2.5 and the dimensions ranging from 0.1-4 micron, e.g., a height of about 0.1-1 micron and a width of about 0.5-4 micron. The low refractive index core C₂ can have a refractive index of 1.45-1.6, and dimensions ranging from 1 to 10 micron, e.g., a height of about 0.2-10 micron and a width of about 1-10 micron. Considering the existing single mode optical fibers, the refractive index of the core layer C₂ may be in the range of 1.45-1.5.

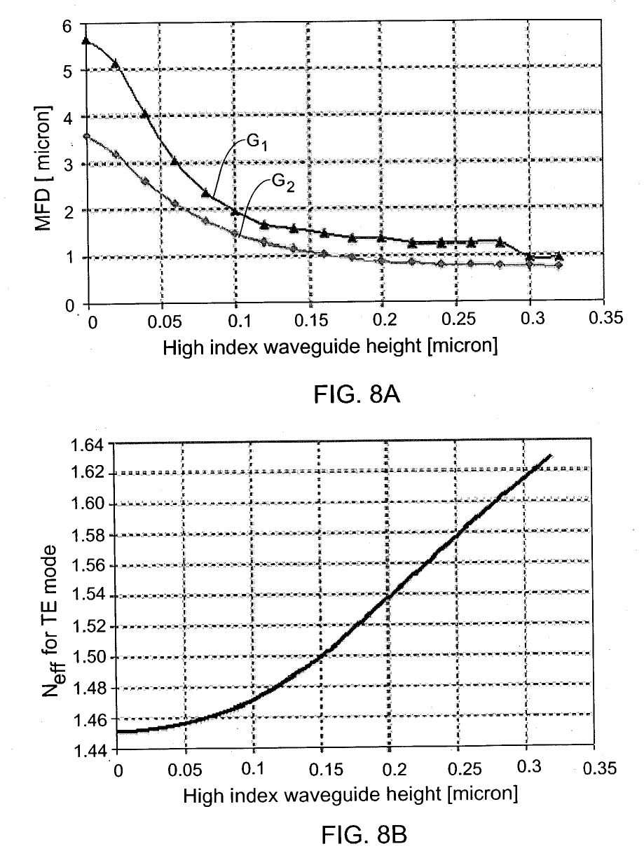

FIGS. 8A and 8B illustrate, respectively, the mode field diameter as a function of the cross-section size of the high-index waveguide C₁, and the effective index (e.g., for the TE polarization) as a function of the cross-section size of the high-index waveguide C₁ in the device according to the invention. Two graphs G₁ and G₂ in FIG. 8A correspond to the waveguide cross-sectional size (height) variations along the X- and Y-axis, respectively. As shown, as the waveguide size is reduced (in either the vertical or horizontal dimension), the optical mode expands (FIG. 8A) and the effective refractive index is reduced (FIG. 8B). When the effective refractive index of the core C₁ waveguide (element's waveguide 103) is similar to that of the low index contrast core C₂ waveguide (connecting waveguide 102), the high index waveguide C₁ is no longer dominant in defining the optical mode, which mode is now defined by the combination of both cores C₁ and C₂. As the cross-sectional size of the high index core C₁ is further reduced, the low index waveguide C₂ becomes dominant in defining the spatial profile of the optical mode. This effect can be obtained with a variety of geometries of the cores C₁ and C₂, as shown in FIGS. 3A-3E, 4A-4E, 5A-5D and 7A-7B. The common element in all these examples is the transition from the single-mode high-index core waveguide 103 to the relatively low-index single-mode core waveguide 102. Changing the cross-sectional size (width, height or both) of the high index core C₁, by a gradual reduction of the dimension of the high index core C₁ in the direction towards the connecting waveguide region 102, causes the transition of the mode between the core segments C₁ and C₂.

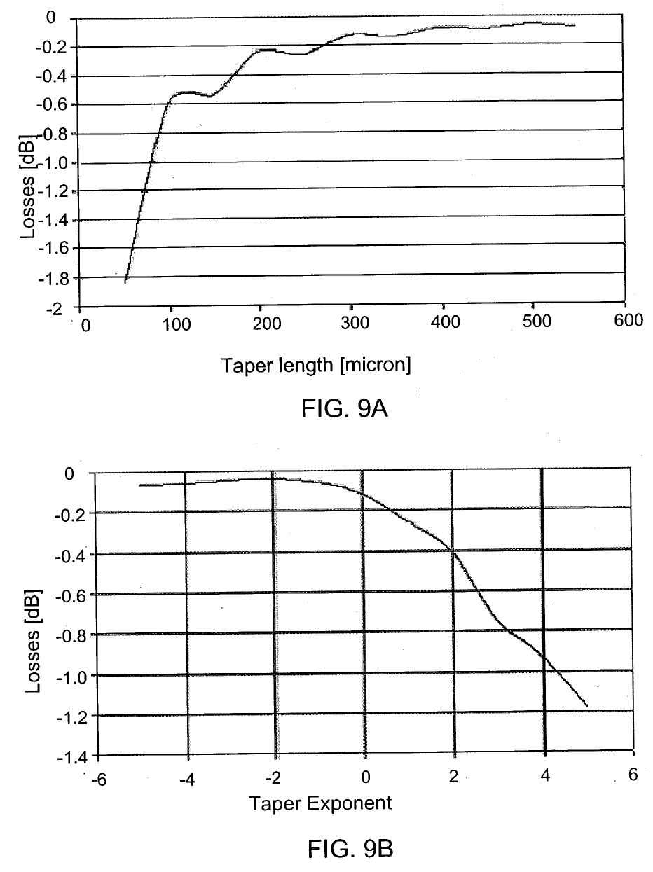

FIGS. 9A and 9B illustrate, respectively, the transition region losses as a function of the linear vertical taper length, and the transition region losses as a function of the vertical taper exponent, in the device of the present invention. As shown, at the taper length of about 500 microns, the losses no longer increase.

The loss of the transition region is dependant mainly on the transition length and not on the exact manner of size reduction. Hence, the technique of the present invention is less demanding from a fabrication standpoint as compared to the previous approaches. Moreover, the transition region of the optical component of the present invention includes both core segments C₁ and C₂, with varying dimensions (cross-section) of at least the high index core C₁ (and C₁′), namely both core segments C₁ and C₂ exist all along the transition region, and the length of the transition region with the varying dimension core (taper) may substantially not exceed 500 micron. It appears that the use of such a short taper component is sufficient for obtaining efficient mode transformation (less then 1 dB).

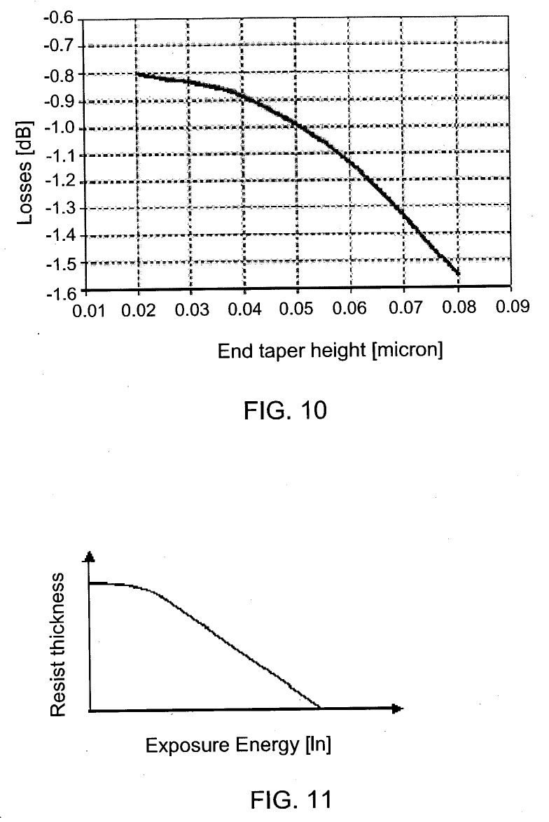

Furthermore, since it is impractical to reduce the dimensions of the high index waveguide 103 to zero (in most fabrication methods at least a few nanometers or even tens of nanometers of the layer material would remain), it is important that the technique of the present invention is tolerant of these further fabrication limitations. This is illustrated in FIG. 10 showing the device losses as a function of the taper end height, i.e., the height of the core C₁ at the side of the connecting waveguide region 102. In the case of horizontal tapering, this point is much more serious then in the vertical tapering, because the horizontal tapering demands a very high precision of the lithography mask, while in the vertical tapering process the taper end height depends only on the etch process and can always be fixed by small over etch of the tapering layer. Hence, in order to obtain the efficient horizontal tapering, the tapering of the additional parts of the transition region is also required.

Since the taper component according to the invention does not critically depend on the profile of the reduction of the high index waveguide core C₁, the gray scale lithography is applicable for the fabrication of the transition region 301. In the gray scale lithography, the thickness of a photoresist layer is correlated to the amount of irradiation. This is illustrated in FIG. 11 showing the typical dependence of the photoresist thickness on the exposure energy.

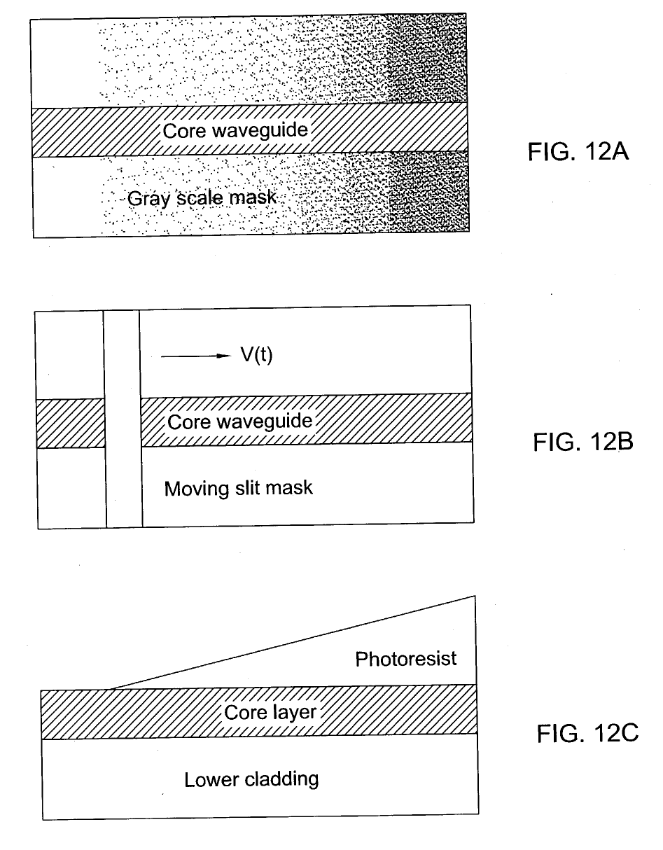

FIGS. 12A-12C exemplify the selective irradiation of the photoresist layer using the vertical lithography technique. As shown in FIG. 12A, a gray scale mask is a mask with varying optical density. When exposing a photoresist layer through such a mask, the amount of light reaching the photoresist layer is determined by the optical density profile of the mask. As shown in FIG. 12B, a moving mask with a slit can be used. The moving mask-with-slit is positioned over the area of interest. By varying the speed of the mask movement, the exposure time (and consequently the amount of irradiation reaching the photoresist layer) is varied along the axis of the mask movement. FIG. 12C shows the photoresist profile resulting from the photoresist exposure by either the gray scale mask or the mask with slit.

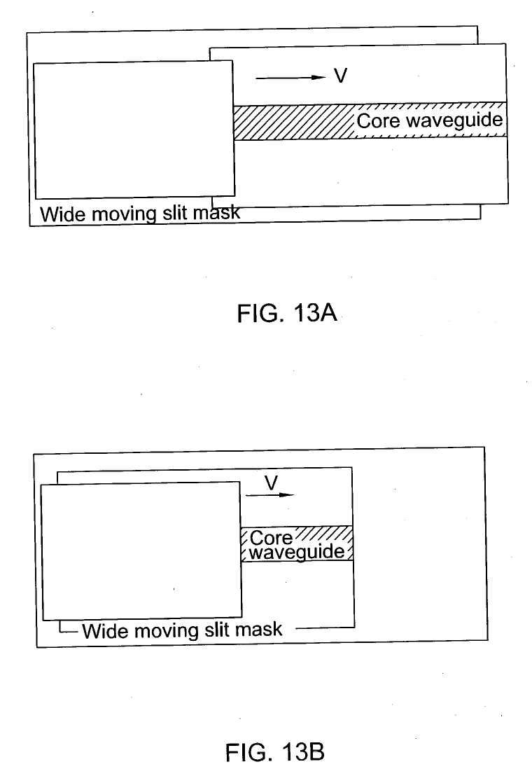

A similar effect can be achieved by using a wide slit and the mask movement with a constant velocity. This is illustrated in FIGS. 13A and 13B showing a wide slit moving mask at, respectively, t=0 (start of exposure), and t=Tₒ (end of exposure).

Thus, the present invention provides for a simple way of manufacturing an optical planar component having a taper region formed by the relatively high and low index cores between top and bottom cladding layers, wherein the high index core segment has a varying cross-section and is either located completely inside the low index core that is partly surrounded by the low index core and partly surrounded by the cladding layer, or is located on top of the low index core. By forming the high index core from a material with a refractive index of about 1.5-2, the low index core from a material with a refractive index of about 1.4-1.6, and cladding layers with lower refractive indices, and utilizing the above-described geometries of the core segments within the transition region, the effective coupling between the fiber 101 and waveguide 103 can be obtained with a relatively short length of the taper region (transition region containing the cross-section variation of the high index core), e.g., about 500 microns.

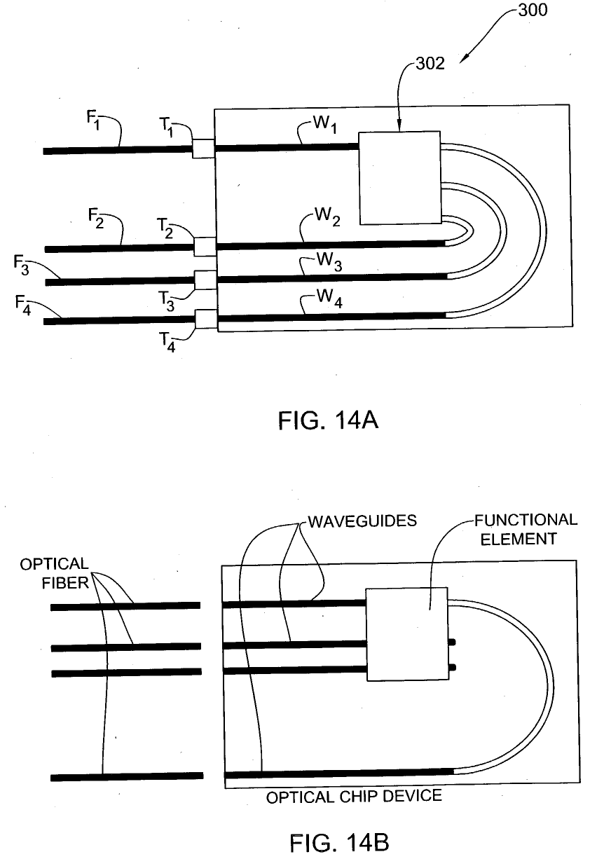

The technique of the present invention utilizing a planar optical taper between an input/output fiber and a functional optical element can advantageously be used for both input and output fiber coupling at the same facet of the functional device. This is schematically illustrated in FIG. 14A, showing an optical chip device 300 that includes an optical functional element 302 and is designed to allow light input and output via optical fibers F₁-F₄ at the same facet 300A of the device. This is implemented by arranging an input waveguide W₁ and output waveguides W₂-W₄ in the optical device at the same facet of the device and coupling the fibers F₁-F₄ and waveguides W₁-W₄, respectively, via transition regions T₁-T₄ of a taper structure, which may be constituted by separate taper structures (30 in FIG. 2) or a multiple transmission region taper (230 shown in FIGS. 7A-7B). The optical functional element can be a switch, tunable filter, variable optical attenuator, power splitter, modulator or any other optical element capable of manipulating the amplitude and/or phase of the guided light.

Input light Lᵢₙ is supplied from one or more optical fiber (one such fiber F₁ in the present example of FIG. 14A) and, while being coupled from the fiber F₁ to waveguide W₁ via the taper structure (its transition region T₁), enters the device through the facet 300A to thereby propagate through the waveguide W₁ inside the optical chip device towards the functional element 302. Light emerging from the functional element (through three spaced-apart channels in the present example) is further guided in the output waveguides W₂-W₄ towards the same facet 300A of the device where the waveguides W₂-W₄ are coupled to output optical fibers F₂-F₄ via transition regions T₂-T₄ of the taper structure. To facilitate such a single-side coupling, the output waveguides have to curve and realize a 180°-turn of the direction of light propagation.

As shown in FIG. 14B, an alternative embodiment of the invention utilizes an arbitrary output direction from the functional element, i.e., the turn of the direction of light propagation is carried out by the functional element itself The functional elements of the kind capable of supporting the direction change include a photonic bandgap device and a ring resonator.

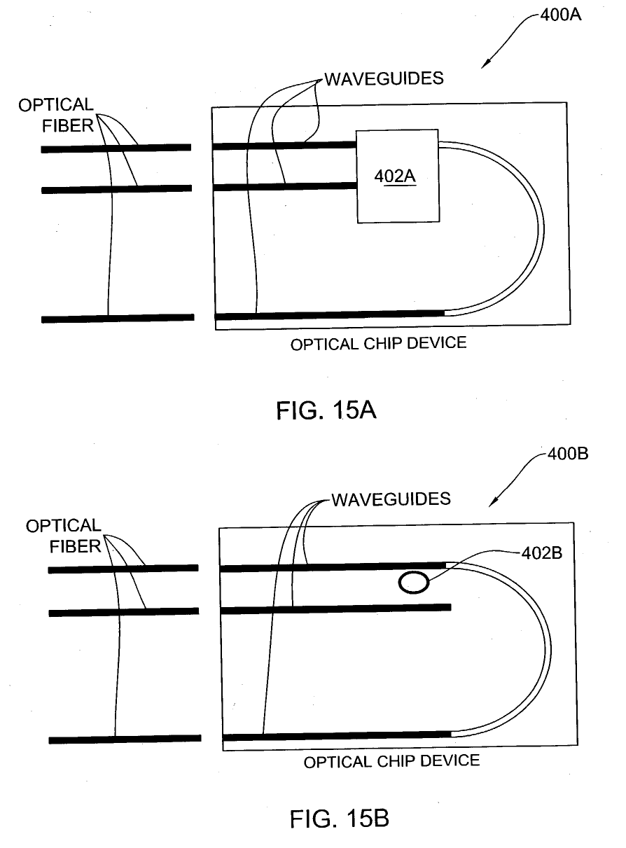

FIGS. 15A and 15B exemplify optical chip devices 400A and 400B of the present invention with arbitrary output direction from, respectively, a photonic bandgap device 402A and a ring resonator device 402B.

A photonic bandgap device [Journal of Lightwave Technology, Vol. 19, No. 12, December 2001 p.1970] uses a repetitive crystal like structure to create local resonance conditions for light. With a specific design of such a structure, the light can be directed in any required direction. A ring resonator [IEEE Photonics Technology Letters, Vol. 11, No. 6, June 1999 p. 691] is another example of a device that changes the direction of light by virtue of its structure. The output beam is directed in an arbitrary direction as determined by the angular orientation of the output fiber with respect to the device. In the devices described in these publications, output light is not directed to the input facet of an optical chip device, but rather to a different facet. To enable bundling of input and output fibers in the same array or physical arrangement, and as a result, enable coupling of the input and output fibers in a single alignment step, the present invention provides for changing the direction of light emerging from a functional element so as to provide the light propagation to the input facet of the integrated optical device.

Standard optical waveguides have minimum turn radius of several millimeters. Sharper turns induce radiation losses, which degrade the performance of the device. However, tighter bends can be obtained by increasing the difference between the refraction indices of the waveguide core and the surrounding materials. For example, the minimum turn radius of waveguides with 1% index difference is 3 mm, while increasing the index difference to 25% (e.g., □n=2−1.45˜0.5) enables turn radii of 20 micron. Tighter bends would enable a higher density of input and output ports and hence smaller or denser optical devices. The device of the present invention can be easily manufactured by integrated technology, utilizing appropriate wave guiding layer structure and layer patterning to provide such a waveguide arrangement, at which all optical interconnections between the waveguides and input and output fibers are located at the same facet of the device.

Those skilled in the art will readily appreciate that various modifications and changes can be applied to the embodiments of the invention as hereinbefore exemplified without departing from its scope defined in and by the appended claims.

1. A planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region such that the first core segment is spaced from at least one of the cladding layers by said second core segment, a cross-sectional size of the first core segment being reduced along the transition region in a direction towards the optical fiber, thereby forming a sloped interface shorted than 1 mm, at that end of the transition region where the cross-sectional size of the first core segment is minimal an optical field being confined primarily in the second connecting waveguide.

2. The component according to claim 1, wherein the dimensions and refractive indices of the first and second core segments are selected such that the first and second core waveguides are single mode waveguides.

3. The component according to claim 1, wherein the connecting waveguide is configured to have an optical mode matching that of the optical fiber to support the optical mode propagating from the optical fiber to the connecting waveguide.

4. The component according to claim 3, wherein the connecting waveguide has a cross-sectional size and a core to cladding refractive index difference substantially equal to those of the optical fiber.

5. The component according to claim 3, wherein the connecting waveguide has a cross-section size smaller and a core to cladding refractive index difference higher than those of the optical fiber, the optical mode propagating from the optical fiber into the connecting waveguide being thereby supported by the connecting waveguide and being mostly distributed in the cladding of the connecting waveguide than in the core thereof.

6. The component according to claim 1, wherein the first core segment is located on top of the first cladding layer and is spaced from the second cladding layer by the second core segment.

7. The component according to claim 1, wherein the second cladding layer has a varying cross-sectional size.

8. The component according to claim 1, wherein the first core segment is located inside the second core segment, and is therefore spaced from both the first and second cladding layers by the second core segment material.

9. The component according to claim 1, wherein said reduction of the cross-sectional size of the first core segment results from a reduction of the first core segment in one dimension.

10. The component according to claim 1, wherein said reduction of the cross-sectional size of the first core segment results from a reduction of the first core segment in two dimensions.

11. The component according to claim 1, comprising an additional transition region, the two transition regions being arranged in a spaced-apart relationship between the first and second cladding layers, said additional transition region including an additional first core segment extending along the additional transition region while being physically adjacent to a second core segment on top thereof, said additional first core segment having a refractive index higher than those of the cladding layers and the second core material and having a reduced cross-sectional size all along the additional transition region in a direction parallel to the cross-sectional size reduction of said first core segment.

12. The component according to claim 11, wherein the second core segments of the two transition regions are segments of the same core layer.

13. The component according to claim 1, wherein said first core segment is made of a material including at least one of the following: Silicon, Silicon Nitride, Tantalum Pent Oxide, optical polymers, Zinc Oxide, and sol gel based glasses.

14. The component according to claim 1, wherein said second core segment material includes at least one of the following: Silicon Oxide, Germanium doped silicon oxide, silicon oxinitride, sol gel glasses and optical polymers.

15. The component according to claim 1, wherein the cladding layer has a thickness of about 3-20 micron.

16. The component according to claim 1, wherein the cladding layer is made of a material with a refractive index of about 1.44-1.6.

17. The component according to claim 1, wherein the first refractive index n₁ is about 1.6-3.5.

18. The component according to claim 1, wherein the first core segment has the cross-sectional size ranging from 0.1-4 micron.

19. The component according to claim 18, wherein the first core segment has a height if about 0.1-1 micron and a width of about 0.5-4 micron.

20. The component according to claim 1, wherein the second refractive index n2 is about 1.45-1.6.

21. The component according to claim 1, wherein the second core segment has a size of about 1-10 micron.

22. The component according to claim 21, wherein the second core segment has a height is about 0.2-10 micron and a width of about 1-10 micron.

23. The component according to claim 1, wherein said second connecting waveguide is coupled to an optical fiber.

24. A planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region, the first core segment being located inside the second core segment and being spaced from the cladding layers by said second core segment material, a cross-sectional size of the first core segment being reduced along the transition region in a direction towards the optical fiber, thereby forming a sloped interface between the first and second core segments, such that at that end of the transition region where the cross-sectional size of the first core segment is minimal an optical field is confined primarily in the second connecting waveguide.

25. A planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region, the first core segment being located on top of the second core segment and being spaced from one of the cladding layers by said second core segment material, a cross-sectional size of the first core segment being reduced along the transition region in a direction towards the optical fiber, thereby forming a sloped interface between the first core segment and the other cladding layer, at that end of the transition region where the cross-sectional size of the first core segment is minimal an optical field being confined primarily in the second connecting waveguide.

26. An optical device having a functional optical element connectable to at least one optical fiber via at least one first waveguide, the optical device comprising a taper structure located at an input/output facet of the device and defining an optical path for light propagation in between said at least one first waveguide and said at least one optical fiber, the taper structure comprising a waveguide structure defining at least one transition region between, respectively, the at least one first waveguide and the at least one optical fiber, the transition region being formed by first and second cladding layers and first and second core segments, the first core segment being formed by a core of said first waveguide having a refractive index n₁, and the second core segment being formed by a core of a second connecting waveguide having a refractive index n₂<n₁, the first and second core segments being physically adjacent to one another all along the transition region such that the first core segment is spaced from at least one of the cladding layers by said second core segment, a cross-sectional size of the first core segment being reduced along the transition region in a direction towards the optical fiber, thereby forming a sloped interface shorted than 1 mm, at that end of the transition region where the cross-sectional size of the first core segment is minimal an optical field being confined primarily in the second connecting waveguide.

27. The device according to claim 26, comprising at least one additional first waveguide connecting said functional element to an optical fiber via the taper structure on said input/output facet of the device.

28. The device according to claim 27, wherein said at least one additional waveguide is an input/output waveguide of the functional element and is configured as a curve realizing a 180° turn.

29. The device according to claim 27, wherein said functional optical element is operable to effect a change in light propagation direction via at least one of the first waveguides.

30. A planar optical component defining an optical path for light propagation in between a first waveguide and an optical fiber, the optical component comprising a waveguide structure defining a transition region between the first waveguide and the optical fiber formed by first and second cladding layers and first and second core segments, the first core segment being formed by a core of said first waveguide having a refractive index n₁ of about 1.6-3.5, and the second core segment being formed by a core of a second connecting waveguide having a refractive index n₂<n₁, the first and second core segments being physically adjacent to one another all along the transition region such that the first core segment is spaced from at least one of the cladding layers by said second core segment, a cross-sectional size of the first core segment being reduced along the transition region in a direction towards the optical fiber, thereby forming a sloped interface shorted than 1 mm, at that end of the transition region where the cross-sectional size of the first core segment is minimal an optical/field being confined primarily in the second connecting waveguide.

31. A method of manufacturing an optical component, the method comprising:
(i) depositing on a bottom cladding layer a first waveguide core layer of a refractive index higher than that of the bottom cladding layer;
(ii) patterning said first core layer by applying an electromagnetic radiation through a gray level mask, to thereby define a first core layer segment of a predetermined length with a cross-sectional size of said first core segment reducing along said length;
(iii) providing a second waveguide core layer coating on said first core segment and regions of the bottom cladding layer outside said first core segment, said second core layer having a refractive index higher than that of the bottom cladding layer and lower than that of the first core layer;
(iv) depositing a top cladding layer on said second waveguide core layer.

32. The method according to claim 31, wherein the second waveguide core layer coating is provided by depositing the second waveguide core layer on the patterned first core segment and the regions of the bottom cladding layer outside said first core segment.

33. The method according to claim 31, wherein said providing of the second waveguide core layer coating comprises:
depositing the second waveguide core layer on top of the bottom cladding layer;
depositing the first core layer on top of the second core layer;
upon patterning the first core layer to define said first core segment, depositing a further layer of said second waveguide core, and patterning said further layer to thereby provide said coating of the regions of the bottom cladding layer outside the first core segment.

34. The method according to claim 31, wherein said patterning comprises applying an electromagnetic radiation through a moving mask with a slit, to thereby define the first core layer segment of the predetermined length with the cross-sectional size of said first core segment reducing along said length.

35. A method of manufacturing an optical component, the method comprising:
(i) depositing on a bottom cladding layer a second waveguide core layer of a refractive index higher than that of the bottom cladding layer;
(ii) depositing on said second waveguide core layer, a first waveguide core layer of a refractive index higher than those of the second core layer and the cladding layer;
(iii) patterning said first core layer by applying an electromagnetic radiation through a gray level mask, to thereby define a first core layer segment of a predetermined length with a cross-sectional size of said first core segment reducing along said length;
(iv) depositing a top cladding layer on said first waveguide core layer and regions of the second layer outside the first core segment.
